(19) United States
(12) Patent Application Publication
(10) Pub. No.: US 2016/0234919 A1
(43) Pub. Date: Aug. 11, 2016

(54) Energy saving HID lamp

(71) Applicant: Articmaster Inc., Las Vegas, CA (US)

(72) Inventor: Cass Khoo, Alameda, CA (US)

(73) Assignee: Articmaster Inc., Las Vegas, CA (US)

(21) Appl. No.: 15/013,089

(22) Filed: Feb. 2, 2016

Related U.S. Application Data
(60) Provisional application No. 62/113,142, filed on Feb. 6, 2015.

(51) Int. Cl. H05B 41/38

(52) U.S. Cl. CPC H05B 41/38

(57) ABSTRACT

An energy saving HID lamp with a long lifespan is provided. In an embodiment of the invention, the lamp comprises at least two arc tubes within a quartz enclosure wherein each of the arc tubes has a tungsten cathode tip, an anode and xenon gas between the two electrodes. Only one arc tube is illuminated each time the power is switched on. A control system connected to the ballast circuitry provides dimming up to 50% of the total power of the lamp. Further a motion sensor and a preset timer positioned within the control system provide added energy savings and make the lamp highly suitable for street lighting, public parking and such purposes. The igniter is positioned at the base of the lamp so that the ballast can be located at a convenient location for easy servicing and handling.

### CROSS-REFERENCE TO RELATED APPLICATION

This patent application claims the priority benefit under 35 U.S.C. §119(e) of U.S. Provisional Applications No. 62/113,142 filed on Feb. 6, 2015, the contents of which are herein incorporated by reference.

### FIELD OF THE INVENTION

The present invention relates generally to arc lamps and specifically to high intensity discharge (HID) lamps. In particular, the design of a HID lamp with energy saving capability is provided.

### BACKGROUND OF THE INVENTION

HID lamps are well known in the art for their extremely good color rendition and have therefore been widely used in open spaces, movies theaters, street lighting, parking lots etc. However, HID lamps suffer from the drawback that they cannot start up at their full brightness immediately after they are switched on, since the gas inside the arc tube takes time to heat up. Additionally, every time the light is switched off, a re-strike time of 5 to 10 minutes is needed before the lamp can be switched on again. These lamps are thus not suited to situations where the lamps are required to switch lights on and off instantly or in emergency situations like power outages. Their use is limited to places where very bright light is needed for long periods of time without any power interruption. However, HID lamps are still preferred because of their bright illumination that mimics sunlight. In order to fully benefit from the advantages that HID lamps offer, it is important to have HID lamps with instant switching capability.

Further, continuous use of HID lamps for lengthy periods of time deteriorates the lamp and reduces their life span, since these lamps operate at very high pressures and temperatures. For example, metal halide lamps have a rated life of about 16,000 hrs but they work well only for about 8000 hrs and then lose their brightness and produce much less light than their intended light output. In actual practice, very high intensity may not be required for extended periods of time especially when used for street lighting purposes or at parking places. A lot of energy could be saved if HID lamps were to operate at a much lower wattage at specific times of the night and have a control system that could increase or decrease the light intensity at various times. This would not only save energy by lowering the temperature of the lamp, but would also improve its life span and thereby its efficiency.

The igniter control circuitry for producing the arc, is generally positioned within the ballast which must be at a distance of about 3 ft. or less from the lamp in order to reduce voltage loss along the length of the cable. The ballast's close proximity to the lamp, is inconvenient case of servicing, repair or any other type of emergency situation. It would be advantageous to have the ballast on the ground to enable easy service and handling in case of an emergency situation.

The present invention seeks to overcome all of the foregoing problems by providing a highly efficient HID lamp with energy saving capability.

### SUMMARY OF THE INVENTION

The objects and advantages of the present invention are accomplished by utilizing multiple arc tubes. The two arc tubes each comprising two electrodes, a pointed tip cathode and an anode, are enclosed inside a quartz enclosure. The arc tubes are positioned adjacent to each other and displaced in height so that they do not shadow each other. The igniter is positioned at the base of the lamp and within the lamp fixture.

The purpose of having two arcs is to increase the life span of the lamp and also for instantly lighting the lamp. The lamp has a switching mechanism such that only one arc lights up when the power is switched on. When the lamp is switched on the next time, the second lamp lights up. Further, since the arcs are displaced from each other, maximum light output is realized each time the lamp is switched on.

In one aspect of the invention, an energy saving HID lamp is disclosed comprising at least two arc tubes positioned inside a quartz enclosure, and further comprising a lamp base, an igniter positioned within the base of the lamp, a ballast and a control system designed to control the light intensity. The two arc tubes within the lamp, each comprise a cathode, anode and a mixture of gases that gets ionized when ignited. In one embodiment, the gas mixture comprises xenon. The two tubes are positioned at different heights with respect to each other. The ballast is an electronic ballast and has a programable microprocessor. When the power is switched on, only one arc tube lights up while the other is off. When the power is switched on again, the other arc lights up. This way, at any given time, only one arc is lit so that the lamp has a prolonged lifespan. For example, each arc tube for a xenon lamp has a rated life of about 10,000 hrs. By lighting up only one arc at a time, the life span can be enhanced to two-fold that is at least about 16,000 hrs.

A dimming circuit is located within a control system connected to the ballast which is capable of reducing the light intensity to up to 50% of the total intensity so that the lamp can be at its lowest intensity during specific times. The microprocessor in the ballast can be programmed to control the power and hence the intensity of the lamp. In one embodiment of the invention, the control system has a motion sensor that detects the presence of people or animals at which point the lamp intensity is increased to it highest power. The control system further comprises a preset timer that determines the number of hours the light is lit. The base of the lamp is a standard E39 or E40 base.

In another aspect of the invention, for high power arc tubes (250 W or more), the igniter circuit is positioned within the ballast. In one embodiment, the base is a modified G22 base with a circular cross section.

In yet another aspect of the invention, a method of improving the efficiency of a HID lamp using the apparatus as discussed above is disclosed. The method comprises the steps of providing at least two arc tubes within the quartz enclosure, providing a control system that lights up only one tube when the power is on and the other tube lights up when the power is switched on the next time. Preferably the arc tubes are positioned at different heights to ensure maximum light illumination is achieved. The method further comprises providing a dimming circuit located within the control system for varying the light intensity. The dimming circuit is controlled by a programmable microprocessor positioned inside the ballast. A motion sensor and a preset timer are connected to the ballast.

### BRIEF DESCRIPTION OF THE DRAWINGS

FIG. 1 is a schematic representation of a xenon lamp with 2 arc tubes within the igniter.

FIG. 2 is a schematic representation of the lamp and the ballast circuitry.

FIG. 3 is a schematic representation of a xenon lamp with the modified G22 circular base.

FIG. 4 is the modified G22 circular lamp base

FIG. 5 shows the modified G22 circular base that fits into the standard socket.

### DETAILED DESCRIPTION

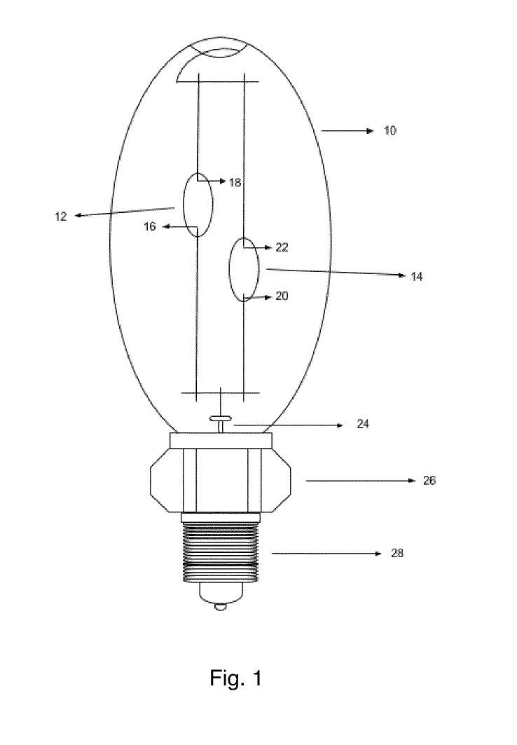

FIG. 1 shows the dual arc xenon lamp of the present invention. Two arc tubes 12 and 14 are positioned inside a quartz lamp 10, with one tube 12 at an elevated position with respect to the second one, 14. Positioning the tubes in this way ensures they do not shadow each other and maximum light output is achieved with minimum light blockage. The arc tubes 12 and 14 each have a pointed cathode tip 18 and 22 and an anode, 16 and 20. The arc tubes are filled with high proportions of xenon gas 17, and negligible traces of mercury. However, for other HID lamps, mercury, sodium or metal halide gas is used.

In one embodiment of the invention, the igniter circuitry for starting the arcs are positioned within fixture, 26 of the lamp via a connecting bar 24. The electronic ballast may be positioned on the ground at a large distance from the lamp up to about 66 ft. which enables convenient icing and handling. The lamp has a standard threaded E-style base, 28 compatible with E-39 or E-40 sockets.

The lamp is designed in a way that only one arc is ignited by the igniter circuitry when the power is switched on. The second arc tube remains off during the entire period when the power is on. Once the power is switched off and on again, the second arc is lighted. This way only one arc is lit at any given time time, thereby enhancing the life of the lamp. For example, for a xenon lamp, each arc tube has a life of about 8000 hrs. or rated to 12,000 hrs. Together the dual arc lamp may have a life span of more than 20,000 hrs.

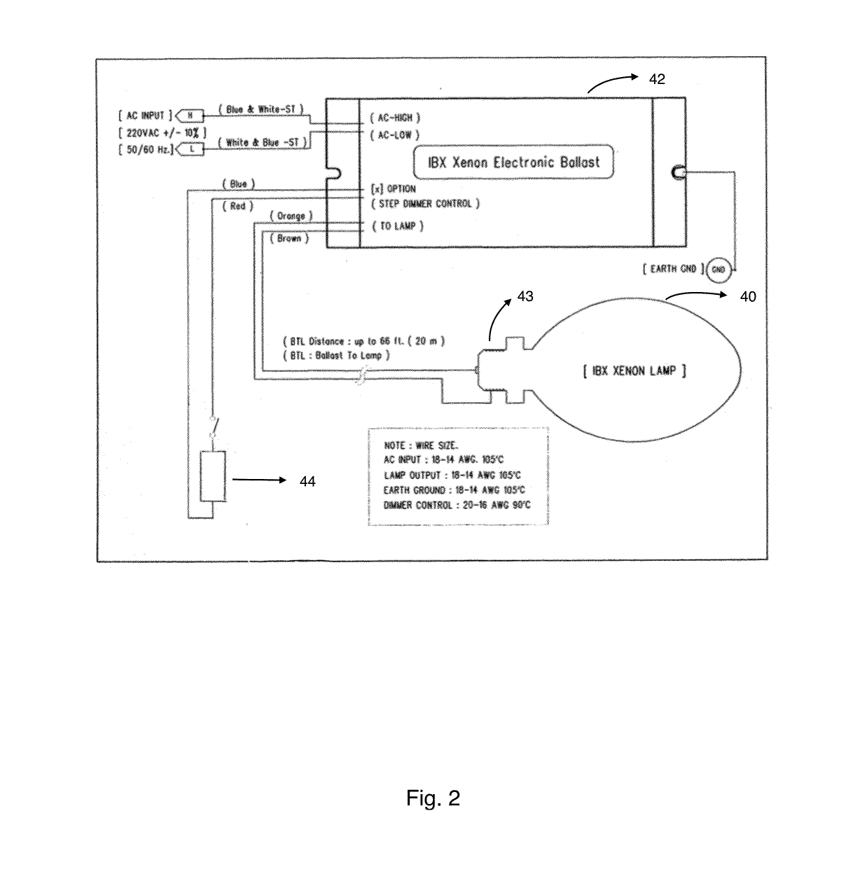

FIG. 2 is a schematic representation of the lamp and the ballast circuitry. A xenon lamp, 40 (2 arc tubes not shown) is connected to the ballast 42. The time for which the lamp is lit as well as the intensity of illumination may be varied by the use of a programmable microprocessor located inside the ballast. A control system 44, provided with a dimming circuitry, motion sensor and preset timer, is connected to the ballast. In one embodiment, the dimming circuit dims the light intensity to almost 50% of its normal output. For example, at 6 pm when the power is switched on, the intensity is lowest at 50% which can be increased to the highest power at 8 pm and remains at that power for about two to four hours and decreases thereafter. The change in intensity from low to high takes place in approximately 8 seconds. The igniter circuitry is positioned within the base, 43 of the lamp. The ballast can then be positioned in a convenient location at almost 66 ft from the lamp. This facilitates easy servicing of the ballast in case of problems.

A motion sensor located inside the control system, 44, detects any moving object like an animal or a human being and instantly turns on the lamp to the highest power if the lamp is in 50% intensity. A preset timer in the system limits the time the lamp is lit; for example, the lamp may be lit from 6 p.m. until 12 midnight at a certain intensity and then at a lesser intensity for the next several hours. The intensity for various periods of time may be programmed by means of the control system. The dimming capability, whereby the intensity of the lamp is controlled during different times further improves the efficiency of the xenon lamp.

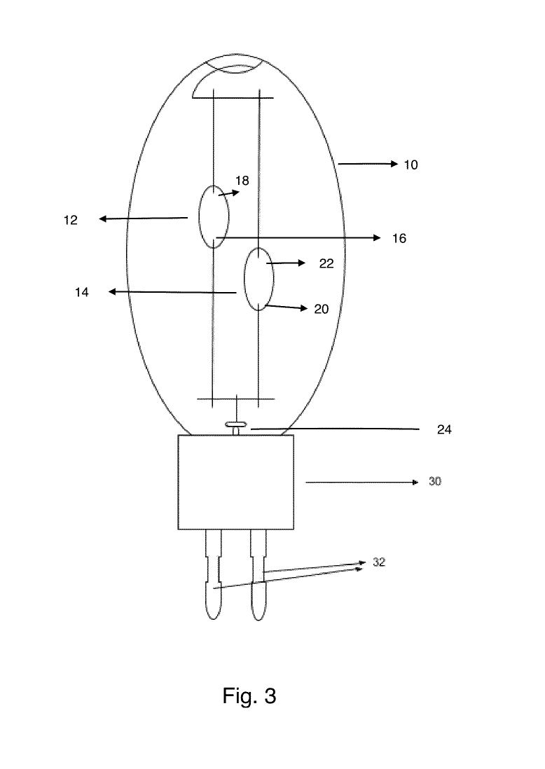

FIG. 3 shows another embodiment of the invention with the the two arc tubes 12 and 14 inside the bulb 10, similar to the one shown in FIG. 1. The igniter, in this case, is positioned within ballast circuitry outside the lamp. For ease of construction, the lamp is provided with a modified G22 ceramic base, 30, having a circular cross section instead of the standard rectangular shape. A circular configuration facilitates easy insertion of the arc tubes into the lamp and maximizes the surface area of contact of glass with the ceramic base. Since ceramics can operate at high temperatures, a larger area can take more heat away and reduce stress in places where the glass is in contact with the ceramic.

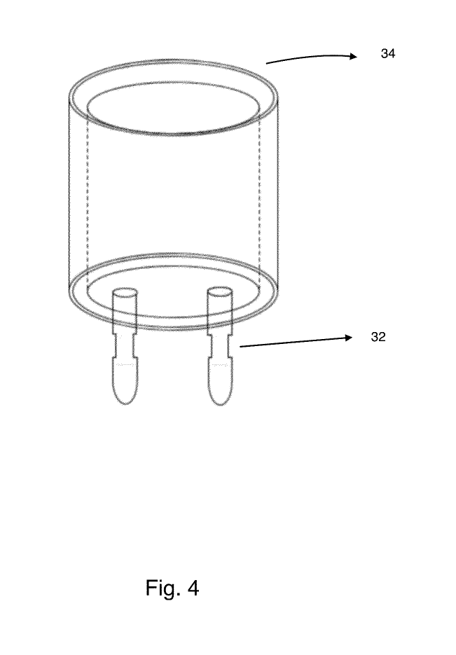

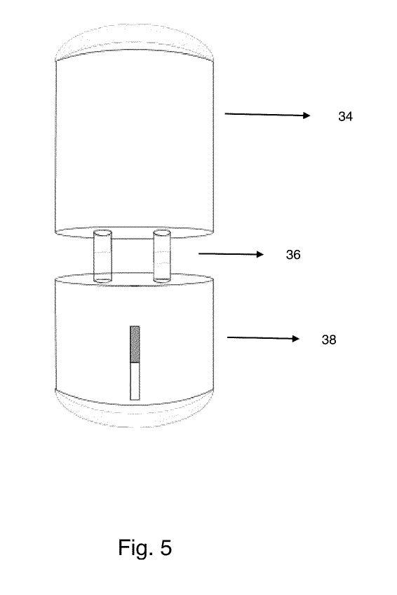

FIG. 4 is a top view of the modified G22 base showing a circular cross section, 34 and the male connector pins 32. FIG. 5 clearly shows the modified G22 base that fits into the standard lamp socket 38.

In one embodiment of the invention, the xenon lamp described above may have more then two arc tubes and the number of tubes that light up each time the power is on, may be controlled to achieve an even larger lifespan.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

What is claimed:

1. A HID lamp comprising:
at least two arc tubes positioned inside a quartz enclosure, each comprising a cathode, anode and a mixture of gases;
a lamp base;
an igniter positioned within the base;
a ballast connected to the lamp;
a control system connected to the lamp and the ballast; said system designed to control the light intensity.

2. The HID lamp of claim 1, wherein said ballast is an electronic ballast comprising a programmable microprocessor.

3. The HID lamp of claim 1, wherein the lamp base is a modified G22 base with a circular cross section.

4. The HID lamp of claim 1, wherein said control system comprises a dimming circuit.

5. The lamp of claim 4, wherein said control system further comprises a motion sensor.

6. The HID lamp of claim 5, wherein said control system further comprises a preset timer.

7. A method of improving the efficiency of a HID lamp using the apparatus of claim 1, comprising the steps of:
providing at least two arc tubes within a quartz enclosure;
providing a means to light up only one tube when the power is on and the other tube lights up when the power is switched on the next time;
providing a control system for varying the light intensity.

8. The method of claim 7, wherein said control system comprises a dimming circuit.

9. The method of claim 8, wherein said dimming circuit is controlled by a programmable microprocessor positioned inside the ballast.

10. The method of claim 9, wherein said control system further comprises a motion sensor.

11. The method of claim 10, wherein said control system further comprises a preset timer.
